(19) United States
(12) Patent Application Publication
(10) Pub. No.: US 2012/0028783 A1
(43) Pub. Date: Feb. 2, 2012

(54) Plasticized vinyl acetate coplymer binder compositions for chopped strand mat

(76) Inventors: Hendrikus van Boxtel, Frankfurt am Main (DE); Paolo Bavaj, Dusseldorf (DE); Steve Laborda, Hofheim am Taunus (DE); Marc T. Ratering, Liederbach am Taunus (DE); Peter M. Zeimentz, Mainz (DE)

(21) Appl. No.: 13/134,826

(22) Filed: Jun. 17, 2011

Related U.S. Application Data
(60) Provisional application No. 61/398,486, filed on Jun. 25, 2010.

(51) Int. Cl. C03C 14/00; C08K 5/10; C08L 67/02; C08L 31/04

(52) U.S. Cl. 501/32; 524/564; 524/315; 524/296; 525/176

(57) ABSTRACT

A plasticized binder composition suitable as a binder for chopped strand mats comprising (a) a copolymer obtainable by reacting; (i) 60-95 pphwm of vinyl acetate; and (ii) 5-40 pphwm of vinyl ester of α-substituted alkanoic acid; and b) a plasticizer, wherein the weight ratio of copolymer/plasticizer is from 1 to 6.

### CLAIM FOR PRIORITY

This non-provisional application claims the benefit of the filing date of U.S. Provisional Patent Application Ser. No. 61/398,486, of the same title, filed Jun. 25, 2010. The priority of U.S. Provisional Patent Application Ser. No. 61/398,486 is hereby claimed and the disclosure thereof is incorporated into this application by reference.

### FIELD OF THE INVENTION

This invention relates to plasticized polyvinyl acetate copolymer binder compositions for chopped strand mats of the class used in composite structures. The binders are typically soluble in styrene monomer and resin employed to produce composite structures, typically a polyester or vinyl ester resin.

### BACKGROUND OF THE INVENTION

Chopped strand mats (CSMs), formed from glass fibers or other mineral strands, are commonly used as reinforcement in plastic or composite products. A chopped strand mat is typically made up of randomly oriented chopped glass fiber strands that are bonded together with a thermoplastic or thermoset resin. A chopped strand mat is typically laminated or impregnated with resin which dissolves the binder and is molded to form a variety of articles such as boat hulls and vehicle parts.

There are numerous ways to manufacture chopped strand mats. An example of a known chopped strand mat forming apparatus and method is disclosed in U.S. Pat. No. 2,719,336 to Stotler (“Stotler”), the disclosure of which is incorporated herein by reference. Conventional manufacturing processes involve the formation of the mat and the takeup of the finished mat on a roller or reel.

A variety of plasticized binder compositions to provide strength to CSMs have been utilized. One commercially available product, Vinamul® 8839 CSM binder, for example, is a colloid-stabilized polyvinyl acetate/polymeric plasticizer resin system. Other CSM polyvinyl acetate binder compositions are plasticized with dihydroxy benzenes or phthalate esters. It has been proposed to reduce the glass transition temperatures of polyvinyl acetate binders for use in CSMs by utilizing comonomers. See P. Wang et al., Boli Xianwei 2008 (1), 17-20.

Other proposed binder resins for mineral fibers include vinyl ester/ethylene copolymers as seen, for example, in WO 2010/034658. See also U.S. Pat. No. 6,511,561 to Kolhammer et al, also published as EP 0 965 672 and EP 0 959 114. Vinyl acetate binder and adhesive compositions are also seen in the following references: EP 1 916 275 of Killat, also published as United States Patent Application Publication No. US 2008/0098933; JP 2008-045228; U.S. Pat. No. 5,668,216; JP 01213477; and EP 1 482 081.

Polyvinyl acetate binder compositions for CSMs are typically plasticized with high levels of plasticizer to provide for better drape, faster wet out, better conformability and softer hand. These properties however are improved at the expense of tensile strength which is reduced when plasticizer is added, sometimes to unacceptably low levels.

### SUMMARY OF THE INVENTION

The compositions of this invention provide surprisingly high tensile strength to CSMs while preserving other properties, for example, fast wet out. There is provided generally a plasticized binder composition suitable as a binder for chopped strand mats comprising: (a) a copolymer obtainable by reacting 60-95 pphwm of vinyl acetate with 5-40 pphwm of vinyl ester of α-substituted alkanoic acid; and (b) a plasticizer, wherein the weight ratio of copolymer/plasticizer is from 1 to 6.

Further details and uses will become apparent from the discussion which follows as well as the appended claims.

### DETAILED DESCRIPTION OF THE INVENTION

The invention is described in detail below with reference to several embodiments and numerous examples. Such discussion is for purposes of illustration only. Modifications to particular examples within the spirit and scope of the present invention will be readily apparent to one of skill in the art. Terminology used herein is given its ordinary meaning consistent with the exemplary definitions herein.

As used herein, chopped strand mat(s) (CSMs), and like terminology means and includes an adhesively bonded mat of preferably randomly oriented glass or mineral fiber strands. The adhesive is preferably soluble in styrene monomer and the mat typically has a weight in the range of 100-1000 gsm. The chopped strands typically have a length of from 10-100 mm and may be of uniform length or may have an average length in that range.

The abbreviation “pphwm” refers to parts per hundred weight monomer based on monomer supplied to the reaction medium unless otherwise indicated.

The terminology “alkyl(meth)acrylate” refers to alkyl acrylates and alkyl methacrylates, typically C₁-C₁₂ alkyl such as butyl acrylate and so forth.

A “bonded mat” and like terminology refers to a web with a tensile strength that is somewhat self-sustaining, that is, will support its own weight over a finite length, preferably to a breaking length of at least 0.5 cm and typically 2.5 cm or more such as 4 cm or more at a minimum.

Other terminology is noted below.

Typically, polymers of this invention are predominantly comprised of vinyl acetate monomer (VA)

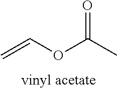

and monomer units from vinyl esters of α-substituted or α-monosubstituted fatty acids such as vinyl 2-ethylhexanoate (V2EH):

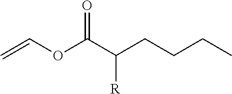

Vinyl 2-ethylhexanoate is where R=ethyl

More generally, any α-monosubstituted alkanoic acid vinyl ester may be used, for example, alkanoic acid esters of the formula:

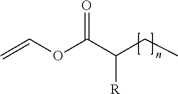

R=straight chain, branched or cyclic alkyl groups, for example, 2-alkylbutanoic acid (n=1) or 2-alkylpropanoic acid is where n=0; n is suitably 2-20. Suitable branched acid alkanoates may also be found in U.S. Pat. No. 5,371,137 to Blincow et al., the disclosure of which is incorporated herein by reference.

Other vinyl esters of α-substituted acids which may be used with or without α-monosubstituted alkanoic acid vinyl ester include vinyl esters of neoalkanoic acids. Vinyl esters of neoalkanoic acids have the following general structure:

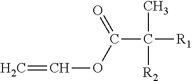

where R₁ and R₂ are alkyl groups which together may typically collectively contain from about 6-8 carbon atoms. Veo Va™ neoalkanoic vinyl esters are available from Hexion Specialty Chemicals of Columbus, Ohio. In VeoVa™ 9, R₁ and R₂ together contain about 6 carbon atoms. In VeoVa™ 10, R₁ and R₂ together contain about 7 carbon atoms. In VeoVa™ 11, R₁ and R₂ together contain about 8 carbon atoms.

In one preferred embodiment, polymers utilized in connection with this invention of this invention also include vinyl esters of aromatic carboxylic acids such as vinyl benzoate (VB):

### Vinyl Esters of Aromatic Carboxylic Acids

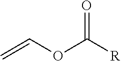

Vinyl benzoate is where R=phenyl. R can be any C₆-C₁₂ aromatic moiety such as naphthalyl, biphenyl etc. whose rings may be further substituted with halogen, alkyl, nitro, amine, and so forth. Further description of suitable aromatic carboxylic acid esters is found in WO 2005/098200, the disclosure of which is incorporated herein by reference.

Optional additional comonomers such as α-olefin monomers acrylics and so forth are also optionally provided. Examples of suitable α-olefin monomers include ethylene, propylene, α-butylene, α-pentylene, α-hexylene, α-octylene and so forth.

Preferred polymers include emulsion interpolymers as described herein, however the optional inclusion of other comonomers is contemplated. Other potentially useful comonomers include 1-heptene, butadiene, hexadiene, isoprene, styrene, methyl styrene, divinyl benzene and the like. Representative of still other ethylenically unsaturated monomers include halogenated monomers such as vinyl chloride, vinylidene chloride, chloroprene, chlorostyrene and the like.

The inventive copolymers may be made by a variety of techniques by which vinyl acetate polymers are made including by bulk, solution, suspension and emulsion processes as is described in the Kirk-Othmer Encyclopedia of Chemical Technology, 4^{th} Ed., Vol. 24, pp. 954-963 (Wiley 1996), the disclosure of which is incorporated herein by reference. The preparation of the inventive compositions can be carried out using continuous or discontinuous processes of free-radical emulsion polymerization. The polymerization may be conducted with the assistance of customary reaction vessels such as loop or stirred reactors. Preference is given to using discontinuous processes such as batch, combined batch/feed stream, pure feed stream processes or feed stream processes onto nucleating particles.

In these processes, water-soluble and/or oil-soluble initiator systems such as peroxodisulfates, azo compounds, hydrogen peroxide, organic hydroperoxides or dibenzoyl peroxide are employed. These may be used either by themselves or in combination with reducing compounds such as Fe (II) salts, sodium pyrosulfite, sodium hydrogen sulfite, sodium sulfite, sodium dithionite, sodium formaldehyde-sulfoxylate, ascorbic acid, as a redox catalyst system. The emulsifiers, and/or where appropriate, protective colloids, additives and/or auxiliaries may be added before, during or after the polymerization. Examples of emulsifiers include alkyl aryl polyglycol ethers and alkyl polyglycol ethers each preferably having from 8 to 50 mol of ethylene oxide units per molecule, block copolymers of ethylene oxide with propylene oxide, alkylsulfonates or alkyarylsulfonates, alkyl sulfates, alkyl and aryl ether sulfates and phosphates each having preferably from 8 to 18 carbon atoms in the lipophilic part and up to 50 ethylene oxide or propylene oxide units in the hydrophilic part, and also monoesters or diesters of sulfosuccinic acid or alkylphenols each having preferably from 8 to 18 carbon atoms in the alkyl radical. A preferred type of emulsifier does not contain linear alkyl phenol units in the lipophilic part.

In addition to, or instead of, other emulsifiers, protective colloids may be used. Protective colloids include polyvinyl alcohols, starches and cellulose derivatives, polyvinylpyrrolidone and so forth. Details as to components and synthesis are found in United States Patent Publication No. US 2010/0130679 of Jakob et al., the disclosure of which is incorporated herein by reference.

Representative of esters of ethylenically unsaturated carboxylic acids which may also be used include alkyl acrylates and methacrylates wherein the alkyl group contains 1 to 12 or 1 to 10 carbon atoms and esters of such acids as butenoic, maleic, fumaric, itaconic and the like. Representative of other esters which have an ethylenic unsaturation and are preferred include vinyl formate, vinyl versatate, and the like. The alkyl acrylates that can be used to prepare the acrylic ester latex binders of this invention include alkyl acrylates and alkyl methacrylates containing 1 to 12, preferably 1 to 10 carbon atoms in the alkyl group. The polymer backbone in the acrylic ester latexes can be either hydrophilic or hydrophobic and it can comprise polymerized soft monomers and/or hard monomers. The soft and hard monomers are monomers which, when polymerized, produce soft or hard polymers, or polymers in between. Preferred soft acrylic ester monomers are selected from alkyl acrylates containing 2 to 8 carbon atoms in the alkyl group and include ethyl acrylate, propyl acrylate, n-butyl acrylate, and 2-ethylhexyl acrylate. The hard acrylic ester monomers are selected from alkyl methacrylates containing up to 3 carbon atoms in the alkyl group and from non-acrylic monomers such as styrene and substituted styrenes, acrylonitrile, vinyl chloride, and generally any compatible monomer the homopolymer of which has a Tg above 50° C. Preferred acrylic ester monomers are selected from alkyl methacrylates containing 1 to 12 carbon atoms in the alkyl group, especially methyl methacrylate. See U.S. Pat. No. 5,021,529 to Garrett.

Further monomers copolymerizable with vinyl esters are ethylenically unsaturated, ionic monomers, for example compounds which bear at least one carboxylic acid, sulfonic acid, phosphoric acid or phosphonic acid group directly adjacent to the double bond unit, or else are bonded thereto via a spacer. Examples include:

α,β-unsaturated C₃-C₈-monocarboxylic acids, α,β-unsaturated C₅-C₈-dicarboxylic acids and anhydrides thereof, and monoesters of α,β-unsaturated C₄-C₈-dicarboxylic acids.

Preference is given to unsaturated monocarboxylic acids, for example acrylic acid, methacrylic acid, and crotonic acid and the anhydrides thereof; unsaturated dicarboxylic acids, for example maleic acid, fumaric acid, itaconic acid and citraconic acid and the monoesters thereof with C₁-C₁₂-alkanols such as monomethyl maleate and mono-n-butyl maleate. Further preferred ethylenically unsaturated ionic monomers are ethylenically unsaturated sulfonic acids, for example vinylsulfonic acid, 2-acrylamido-2-methylpropanesulfonic acid, 2-acryloyloxy- and 2-methacryloyloxyethanesulfonic acid, 3-acryloyloxy- and 3-methacryloyloxypropanesulfonic acid and vinylbenzenesulfonic acid, and ethylenically unsaturated phosphonic acids, for example vinylphosphonic acid.

In addition, as well as the acids mentioned, it is also possible to use the salts thereof, preferably the alkali metal salts thereof or the ammonium salts thereof and especially the sodium salts thereof, for example the sodium salts of vinylsulfonic acid and of 2-acrylamidopropanesulfonic acid.

The ethylenically unsaturated free acids mentioned are present in aqueous solution at pH 11 predominantly in the form of their conjugate bases in anionic form and can, like the salts mentioned, be referred to as anionic monomers.

Any suitable pasticizer may be used such as dihydroxy benzenes or phthallate esters if so desired. Examples of common phthalate plasticizers include, for example, di-isononyl phthalate (DINP), diallyl phthalate (DAP), and di-2-ethylhexyl-phthalate (DEHP) and dibutyl phthalate. The phthalate ester employed may be an ortho ester or a non-ortho ester. Other ester plasticizers which may be employed include phthalate-free plasticizers such as esters of glycerol as described, for example in U.S. Pat. No. 6,652,774 to Zhou et al, the disclosure of which is incorporated herein by reference. Particularly preferred plasticizers are polymeric plasticizers which are described, for example, in U.S. Pat. No. 5,281,647 to Eapen, the disclosure of which is incorporated herein by reference. Such plasticizers include the ester reaction products of diacids and glycols. Useful diacids can contain from 5 to 13 carbon atoms and preferably 6 to 10 carbon atoms. Illustrative but non-limiting examples of the diacids can be aliphatic acids selected from the group consisting of carboxylic acids, their anhydrides and/or their methyl esters, such as sebacic acid, glutaric acid, azelaic acid and adipic acid which is presently preferred. The diols may include 2,2,4-trimethyl-1,3-pentanediol (TMPD glycol) for the purpose of illustration without limitation of other glycol that may be used in the plasticizer. TMPD glycol is of a relatively high molecular weight branched structure; it contains a sterically hindered secondary hydroxyl group and is hydrophobic in nature. Other examples of the hindered diols can be selected from the group consisting of 2 butyl-2-ethyl-1,3-pentane diol, 1,4-cyclohexane dimethanol and hydroxy pivalyl hydroxy-pivalate their substituted species and substituted neopentyl glycol. Short chain diols having from about 2 to 5 carbon atoms may be used, for example, a glycol selected from the group consisting of a butylene glycol, propylene glycol, ethylene glycol and mixtures thereof.

### Examples

The following examples are presented to further illustrate the present invention and should not be taken as limiting the invention. The parts and percentages indicated in the examples are by weight unless noted otherwise.

### Preparation of the Polymer Dispersion

Colloid-stabilized copolymer dispersions were synthesized having the compositions shown in Table 1 according to the emulsion polymerization procedures described above. Preferred compositions of the invention are available from Celanese Emulsions GmbH, including Vinamul® CSM binder products.

Table 2 shows the properties of the polymer dispersions produced. Tg was measured with DSC (heating rate 10° C./min), midpoint according to DIN 51007 was recorded.

TABLE 1
Composition of the examples

| Monomer Composition | Example 1 | Example 2 | Example 3 | Example 4 | Example 5 | Example 6 | Example 7 |
|---|---|---|---|---|---|---|---|
| Vinyl Acetate (wt-%) | 75 | 80 | 70 | 70 | 70 | 70 | 90 |
| Vinyl 2-ethylhexanoate | 25 | 20 | 20 | 20 | 30 | 30 | — |
| (wt-%) | | | | | | | |
| Vinyl benzoate (wt-%) | — | — | 10 | 10 | — | — | — |
| VeoVa 10 (wt-%) | — | — | — | — | — | — | 10 |

TABLE 2
Physical properties of the polymer dispersions produced

| | Solids | Brookfield | | Tg |
|---|---|---|---|---|
| | Content | Viscosity [mPas] | | (Midpoint) |
| No. | [%] | (23° C., 20 rpm) | pH | [° C.] |
| Example 1 | 55.3 | 835 | 4.5 | 21 |
| Example 2 | 55.2 | 1250 | 4.5 | 32 |
| Example 3 | 51.3 | 6430 | 4.2 | 23 |
| Example 4 | 48.6 | 2650 | 4.2 | 22 |
| Example 5 | 55.3 | 2710 | 4.5 | 18 |
| Example 6 | 55.1 | 2060 | 4.4 | 20 |
| Example 7 | 53.0 | 3280 | 4.5 | 29 |

### Application Test Data

### Controls

Commercially available Vinamul 8839 (Celanese Emulsions GmbH), a widely used plasticized poly(vinyl)acetate, was used as a standard and tested as received in direct comparison with the new developed systems.

### Plasticization

Plasticizer Dioplex 400 (a polymeric adipate plasticizer) as received from the supplier was added at 60° C. to the poly(vinyl acetate) co-polymer and stirred for 4 h at this temperature to achieve a homogeneous mixture with 34% plasticizer and 60±1% solids level (if needed, dest. water is added together with the plasticizer to adjust the correct solids level).

### CSM Preparation

As a standard, 450 gsm chopped strand mat at 4% LOI was produced by sprinkling evenly and random 58.4 g of chopped strands on a Mathis oven tray (41×33 cm). When all fibers were suitably disposed in the tray, the tray was placed onto a weighing balance which was adjusted to zero. Then the diluted polymer (app. 5% solids level) was poured over the sprinkled chopped strands with a glass beaker. After all chopped strands had been wetted the tray was tilted partially vertically in such way the polymer was rinsed into each of the four corners each for 10 seconds except the last corner, where the disperstion was held for 20 seconds. The wetted glass strands and the tray were now put onto the weighing balance and by using vacuum, excess diluted polymer was removed until a weight of about 46 grams was reached. This corresponds to a LOI (=loss of ignition weight or binder pick up) of about 4%. Afterwards the tray was put in a Mathis oven at 170° C. for 2 minutes 30 seconds. These mats produced were stored in a climate room (22° C., 50% rh) for at least 24 hours before further testing.

### Determination of LOI

2-3 g of CSM were weight into a weighed porcelain crucible (two specimens of each sample) with a four digit weighing balance. These prepared crucibles were then placed in a muffle furnace which at a temperature of 575±25° C. for 1 hour. After removing from the furnace and cooling in a desiccator to room temperature, the mass of the specimen was redetermined. Loss on ignition (K) can be calculated as follows:

$$K / \% = \frac{B - C}{B} * 100$$

where
   K=loss on ignition
   B=Mass of the specimen before the oven
   C=Mass of the specimen after ignition.

### Determination of Tensile Strength

CSM samples were cut having a sample width of 10 cm and a length between the tensile strength clamps of 20 cm. A Lloyd T100K tensile tester with a pulling speed of 100±10 mm/min was used for the determination of the bonding strength of the binder used for making the CSM. Values are given as an average of at least four determinations.

### Bull's Eye Test for Wet Out

Three 100 mm×100 mm specimens were cut from the CSM. A “bull's-eye” pattern was covered with a piece of transparent film and one specimen placed over the “bull's-eye”. An aluminum plate (125 mm×125 mm×5 mm with a 50 mm diameter hole in the centre) was placed over the specimen locating the 50 mm diameter hole concentric with the “bull's-eye” pattern. The 50 mm diameter hole was quickly filled with styrenated polyester resin (Norsodyne S2010 V from Cray Valley) to the top surface of the plate and a stop-watch was started as soon as the resin came into contact with the mat. The time was recorded that was required for the figures in the “bull's-eye” to become clearly legible. Values are given as an average of at least two determinations.

### Determination of Styrene Solubility

Specimens to be tested were cut to a width of 50 mm and a length of about 20 cm. Due to the styrene monomer used, it is obligatory to work in a fume cupboard, use proper personal protection equipment and read the MSDS of styrene. The pre-conditioned and cut specimens were tested in a fume cupboard by lowering the specimen into styrene monomer present in a 1000 mL glass cylinder (45 cm high, width of 6 cm). To do so a clamp was attached at the bottom of the specimen having a lead weight of 100 g. The specimen was lowered into the cylinder into styrene and the stopwatch was started. A “clamp-scissor” was used to hold the specimen and to prevent it from falling into the cylinder. The time was recorded until the specimen was torn apart by the lead weight and the styrene which solved the mat binder. The quicker the specimen was torn, the higher the styrene solubility. Values are given as an average of at least four determinations.

### Bending Stiffness

Bending stiffness was determined on a Lorentzen & Wettre bending tester (in machine direction, angle 7.5°, 25 mm bending length) with specimens of the dimensions 100 mm×38 mm. Values are given as an average of at least six determinations.

### Test Results

TABLE 3
Application test results

| | | | | | Bending |
|---|---|---|---|---|---|
| | LOI | Tensile strength | Wet | Styrene | Stiffness |
| | [%] | [N/10 cm] | out [s] | solubility [s] | [mNm] |
| Standard | 4.7 | 208 | 170 | 3 | 3.1 |
| Example 1 | 4.0 | 293 | 161 | 2 | 3.6 |
| Example 2 | 4.3 | 254 | 319 | 2 | 2.8 |
| Example 3 | 4.5 | 346 | 210 | 3 | 6.1 |
| Example 4 | 4.9 | 396 | 210 | 3 | 6.4 |
| Example 5 | 4.6 | 232 | 307 | 3 | 2.4 |
| Example 6 | 4.6 | 231 | 291 | 4 | 4.0 |
| Example 7 | 4.5 | 270 | — | 5 | — |

One preferred embodiment is wherein the vinyl ester of α-substituted alkanoic acid includes α-monosubstituted alkanoic acid vinyl ester of the formula:

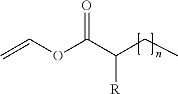

wherein R=straight chain, branched or cyclic alkyl groups and n is from 2-20 and wherein the copolymer is obtainable by reacting from 60-90 pphwm vinyl acetate monomer and from 10-40 pphm vinyl ester of α-monosubstituted alkanoic acid. The plasticized binder composition may be obtainable by reacting from 65-85 pphwm vinyl acetate monomer and from 15-35 pphm vinyl ester of α-monosubstituted alkanoic acid such as vinyl 2-ethyl hexanoate.

In other embodiments, the vinyl ester of α-substituted alkanoic acid includes vinyl esters of neoalkanoic acid of the formula:

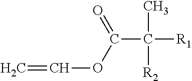

where R₁ and R₂ are alkyl groups which together collectively contain from about 6-8 carbon atoms and wherein the copolymer is obtainable by reacting from 85-92.5 pphwm vinyl acetate monomer and from 15-7.5 pphm vinyl ester of α-monosubstituted alkanoic acid.

In various embodiments of the invention, the weight ratio of copolymer to plasticizer is from 1.25 to 3, such as from 1.5 to 2.5, or still more specifically, wherein the weight ratio of copolymer to plasticizer is from 1.75 to 2.25. The plasticizer comprises an ester plasticizer, such as a phthalate ester. The ester plasticizer may be a polymeric plasticizer such as an adipate polymeric plasticizer.

Another aspect of the invention is directed to a plasticized binder composition suitable as a binder for chopped strand mats comprising (a) a copolymer obtainable by reacting 60-95 pphwm of vinyl acetate, 5-40 pphwm of vinyl ester of α-substituted fatty acids and 5-15 of pphwm of vinyl ester of an aromatic carboxylic acid; and (b) a plasticizer wherein the weight ratio of copolymer/plasticizer is from 1 to 6. The vinyl ester of aromatic carboxylic acid comprises an ester of the formula:

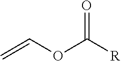

where R is a C₆-C₁₂ aromatic moiety. A preferred vinyl ester of aromatic acid is vinyl benzoate.

The binder of the invention is used in the manufacture of a self-sustaining chopped strand mat comprising from 90-98 weight percent of chopped glass fiber or chopped mineral fiber and from 2-10 weight percent of a plasticized vinyl acetate copolymer binder as described above. The plasticized vinyl acetate copolymer binder is typically present in an amount of from 3% by weight to 6% by weight based on the combined weight of fiber and plasticized vinyl acetate copolymer binder such as from 3.5% by weight to 5.5% by weight based on the combined weight of fiber and plasticized vinyl acetate copolymer binder.

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference, further description is deemed unnecessary. In addition, it should be understood that aspects of the invention and portions of various embodiments may be combined or interchanged either in whole or in part. Furthermore, those of ordinary skill in the art will appreciate that the foregoing description is by way of illustration only, and is not intended to limit the invention.

What is claimed is:

1. A plasticized binder composition suitable as a binder for chopped strand mats comprising:
(a) a copolymer obtainable by reacting:
(i) 60-95 pphwm of vinyl acetate; and
(ii) 5-40 pphwm of vinyl ester of α-substituted alkanoic acid; and
b) a plasticizer;
wherein the weight ratio of copolymer/plasticizer is from 1 to 6.

2. The plasticized binder composition according to claim 1, wherein the vinyl ester of α-substituted alkanoic acid includes α-monosubstituted alkanoic acid vinyl ester of the formula: 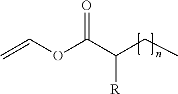
wherein R=straight chain, branched or cyclic alkyl groups and n is from 2-20 and wherein the copolymer is obtainable by reacting from 60-90 pphwm vinyl acetate monomer and from 10-40 pphm vinyl ester of α-monosubstituted alkanoic acid.

3. The plasticized binder composition according to claim 2, wherein the copolymer is obtainable by reacting from 65-85 pphwm vinyl acetate monomer and from 15-35 pphm vinyl ester of α-monosubstituted alkanoic acid.

4. The plasticized binder composition according to claim 2, wherein the vinyl ester of α-monosubstituted alkanoic acid comprises vinyl 2-ethyl hexanoate.

5. The plasticized binder composition according to claim 1, wherein the vinyl ester of α-substituted alkanoic acid includes vinyl esters of neoalkanoic acid.

6. The plasticized binder composition according to claim 5, wherein the vinyl ester of neoalkanoic acid is of the formula: 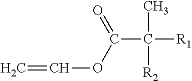
where R₁ and R₂ are alkyl groups which together collectively contain from about 6-8 carbon atoms and wherein the copolymer is obtainable by reacting from 85-92.5 pphwm vinyl acetate monomer and from 15-7.5 pphm vinyl ester of α-monosubstituted alkanoic acid.

7. The plasticized binder composition according to claim 1, wherein the weight ratio of copolymer to plasticizer is from 1.25 to 3.

8. The plasticized binder composition according to claim 1, wherein the weight ratio of copolymer to plasticizer is from 1.5 to 2.5.

9. The plasticized binder composition according to claim 1, wherein the weight ratio of copolymer to plasticizer is from 1.75 to 2.25.

10. The plasticized binder composition according to claim 1, wherein the plasticizer comprises an ester plasticizer.

11. The plasticized binder composition according to claim 10, wherein the ester plasticizer is a phthalate.

12. The plasticized binder composition according to claim 1, wherein the plasticizer is a polymeric plasticizer.

13. The plasticized binder composition according to claim 12, wherein the polymeric plasticizer comprises a polymeric ester plasticizer.

14. The plasticized binder composition according to claim 13, wherein the polymeric plasticizer is an adipate.

15. A plasticized binder composition suitable as a binder for chopped strand mats comprising:
(a) a copolymer obtainable by reacting:
(ii) 60-95 pphwm of vinyl acetate; and
(ii) 5-40 pphwm of vinyl ester of α-substituted alkanoic acid; and
(iii) 5-15 of pphwm of vinyl ester of an aromatic carboxylic acid; and
b) a plasticizer;
wherein the weight ratio of copolymer/plasticizer is from 1 to 6.

16. The plasticized binder composition according to claim 15, wherein the vinyl ester of aromatic carboxylic acid comprises an ester of the formula: 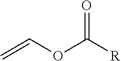
where R is a C₆-C₁₂ aromatic moiety.

17. The plasticized binder composition according to claim 16, wherein the vinyl ester of carboxylic acid comprises vinyl benzoate.

18. A bonded chopped strand mat comprising from 90-98 weight percent of chopped glass fiber or chopped mineral fiber and from 2-10 weight percent of a plasticized vinyl acetate copolymer binder including:
(a) a copolymer obtainable by reacting:
(i) 60-95 pphwm of vinyl acetate; and
(ii) 5-40 pphwm of vinyl ester of α-substituted alkanoicacid; and
b) a plasticizer;
wherein the weight ratio of copolymer/plasticizer is from 1 to 6.

19. The bonded chopped strand mat according to claim 18, wherein the plasticized vinyl acetate copolymer binder is present in an amount of from 3% by weight to 6% by weight based on the combined weight of fiber and plasticized vinyl acetate copolymer binder.

20. The bonded chopped strand mat according to claim 18, wherein the chopped strand mat comprises glass fiber having an average length of from 10 mm to 100 mm and the plasticized vinyl acetate copolymer binder is present in an amount of from 3.5% by weight to 5.5% by weight based on the combined weight of fiber and plasticized vinyl acetate copolymer binder.
